(19) United States
(12) Patent Application Publication
(10) Pub. No.: US 2012/0318745 A1
(43) Pub. Date: Dec. 20, 2012

(54) METHOD FOR INHIBITING FLOCCULATION IN WASTEWATER TREATMENT

(75) Inventor: Keith E. Bowers, Seattle, WA (US)

(73) Assignee: MULTIFORM HARVEST INC., Seattle, WA (US)

(21) Appl. No.: 13/526,300

(22) Filed: Jun. 18, 2012

Related U.S. Application Data
(60) Provisional application No. 61/498,403, filed on Jun. 17, 2011.

(51) Int. Cl. C02F 1/68; C02F 1/00; C02F 101/38

(52) U.S. Cl. 210/698; 210/696

(57) ABSTRACT

Methods for inhibiting, preventing, and disrupting flocculations in wastewater treatment streams.

### CROSS-REFERENCE TO RELATED APPLICATION

This application claims the benefit of U.S. Provisional Application No. 61/498,403, filed Jun. 17, 2011, expressly incorporated herein by reference in its entirety.

### BACKGROUND OF THE INVENTION

Public wastewater treatment plants clean up wastewater in part by growing in it microbial organisms in it that take up carbon, nitrogen, phosphorus, and other nutrients from the wastewater, leaving the water free of those nutrients and more suitable for release to public waterways. Before release, the nutrient-containing solids (the organisms and their remnants) must be removed. This is done through various methods for separating the organisms as a sludge, or “biosolids,” from the water. To aid in these separation processes, a polymeric material is added to flocculate the solids to facilitate the separation and ensure that the separated solid contains as little water with it as possible. (The separated material is usually expensive to dispose of, and the more water that can be removed, the less will be the weight of material for disposal.) A standard polymer base used for this purpose is polyacrylamide, which has a chain of two-carbon repeating units, with one carbon atom in each unit being bonded to a group that contains a nitrogen atom.

Frequently, this nitrogen atom is quaternized so that in water it forms a cation, or the unit is otherwise modified to form a cation, whose positive charge can attract negatively charged sites (anionic sites) on the suspended solids to be flocculated. As each of the many such cationic sites on the polymer chain can do likewise, many individual particles of solid can be bridged and brought together into larger masses (“floccs”) that separate more efficiently from the liquid than their unflocculated counterparts.

Wastewater plants also perform various additional treatments on the cleaned water that passes onward after the organisms have been separated, and upon the additional water that can be further removed (through filtering or centrifuging, for example) from the biosolids. As an example, this additional water removed from the biosolids can contain high concentrations of phosphorus, which it may be desirable to remove. Struvite (magnesium ammonium phosphate) precipitation may be used for this purpose. It is carried out by adding chemicals as necessary to cause the precipitation.

Much of the polymer used for flocculation remains attached to the solids, but these liquid streams that are separated from the solids can contain residual polymer. The residual polymer can interfere with the various additional treatments, including struvite precipitation, if the treatments involve solids whose desired behavior is affected by the polymer. Therefore, it is desirable in some cases to reduce the effects of, or otherwise incapacitate, the residual polymer.

### SUMMARY OF THE INVENTION

In one aspect, the present invention provides a method for inhibiting flocculation in wastewater treatment streams. In one embodiment, the invention provides a method for inhibiting flocculation in a polyacrylamide polymer-containing wastewater treatment stream, comprising adding to the stream an amount of an acid or salt thereof effective to inhibit or prevent flocculation.

In another aspect, the present invention provides a method for disrupting, dissolving, or breaking apart flocculations of solids in wastewater treatment streams. In one embodiment, the invention provides a method for disrupting dissolving, or breaking apart flocculations of solids formed in a polyacrylamide polymer-containing wastewater treatment stream, comprising adding to the stream an amount of an acid or salt thereof effective to disrupt, dissolve, or break apart the flocculations.

In certain embodiments of the above methods, the polyacrylamide polymer is a quaternized polyacrylamide polymer.

In the above methods, the acid or salt thereof is at least partially ionized at wastewater pH. In certain embodiments, wastewater pH is from about 5.5 to about 9.0, for example, from about 7.0 to 8.5.

In certain embodiments, the acid is a carboxylic acid. In certain embodiments, the carboxylic acid has a pKa of about 2.0. In other embodiments, the carboxylic acid has a pKa of about 3.0. In further embodiments, the carboxylic acid has a pKa of about 4.0. In general, the carboxylic acid has a pKa of less than about 5.0. In certain embodiments, the carboxylic acid has two or more carboxylic acid groups. In certain embodiments, the carboxylic acid is a dicarboxylic acid. In one embodiment, the acid is oxalic acid.

### BRIEF DESCRIPTION OF THE DRAWINGS

FIG. 1 is a schematic illustration of a representative method of the invention for adding an acid and/or salt thereof to a wastewater treatment system.

FIG. 2 is a schematic illustration of a representative method of the invention for adding an acid and/or salt thereof to a second wastewater treatment system.

### DETAILED DESCRIPTION OF THE INVENTION

The present invention relates generally to a method for inhibiting flocculation, and more particularly to a method for inhibiting, preventing, or disrupting flocculation in wastewater treatment streams.

In one aspect, the present invention provides a method for inhibiting flocculation in wastewater treatment streams. In one embodiment, the invention provides a method for inhibiting flocculation in a polyacrylamide polymer-containing wastewater treatment stream, comprising adding to the stream an amount of an acid or salt thereof effective to inhibit or prevent flocculation.

In another aspect, the present invention provides a method for disrupting, dissolving, or breaking apart flocculations of solids in wastewater treatment streams. In one embodiment, the invention provides a method for disrupting dissolving, or breaking apart flocculations of solids formed in a polyacrylamide polymer-containing wastewater treatment stream, comprising adding to the stream an amount of an acid or salt thereof effective to disrupt, dissolve, or break apart the flocculations.

In certain embodiments, the acid is a carboxylic acid. Addition of carboxylic acid or a salt of a carboxylic acid can incapacitate the polymer. This may occur because the carboxyl groups of the acid de-protonate or, in the case of salts, the cations disassociate from the salt, thus in either case forming anions that attach to the cationic sites on the polymer, rendering them unavailable for attraction and attachment to other anionic sites. The carboxylic acid (whether as the acid itself or salt thereof) should have a pKa (and if multi-carboxylic, at least one of the pKas) below the pH of the involved wastewater. If the carboxylic acid has more than one carboxylic acid group, then at least one of the pKas should be below the pH of the involved wastewater.

As used herein, the term “polyacrylamide polymer” or “polymer” refers to a polymer having repeating units that include amide repeating units, which can be formed by polymerization of the acrylamide monomers, and is a cationic polyacrylamide. The polyacrylamide polymer used in wastewater treatment and incapacitated by the method of the invention is available from a variety of commercial sources (e.g., SNF commercially available from Polydyne Company, Riceboro, Ga.). In the polymer, at least a portion of the amide units are quaternized and balanced by chloride ions that dissociate from the cationic center in water, leaving cationic sites.

As used herein, the term “acid or salt thereof” refers to an acid in its protonated form (H-A) or its salt form (X⁺ A⁻). Suitable acids include acids effective for association to polyacrylamide polymers, thereby inhibiting or preventing the formation of flocculations that contain polyacrylamide polymer. Suitable acid salts include counter ions (X⁺) such as metal ions (M⁺) such as lithium, sodium, potassium, calcium, and magnesium ions. In certain embodiments, the acid includes more than one acidic group.

In certain embodiments, the acid is a carboxylic acid or salt thereof (i.e., R—CO₂H or R—CO₂⁻X⁺, where R is an organic moiety). In certain embodiments, the carboxylic acid includes more than one carboxylic acid group. Representative carboxylic acids include carboxylic acids that include two carboxyl groups spaced at a distance roughly similar to the space between units on the polymer. These carboxylic acids function well because such acids are essentially completely de-protonated (i.e., ionized) at typical wastewater pH values, thus providing two anionic sites that can associate with or attach to two adjacent polymeric cationic sites.

In certain embodiments, the carboxylic acid has a pKa of less than about 5.0. In certain embodiments, the carboxylic acid has a pKa of about 4.0. In other embodiments, the carboxylic acid has a pKa of about 3.0. In further embodiments, the carboxylic acid has a pKa of about 2.0. The pKas of suitable acids can be as high as the typical pH of the wastewater (e.g., pH 8.0-8.5).

In certain embodiments, the carboxylic acid is a dicarboxylic acid. In one embodiment, the acid is oxalic acid or salt thereof (i.e., HO₂C—CO₂H, HO₂C—CO₂⁻X⁺, or X⁺⁻OC(═O)—CO₂⁻X⁺).

The following is a description of a representative method of the invention using oxalic acid as the acid.

Oxalic acid dihydrate was added to final supernate at a rate of 6 pounds per 1000 gallons of final supernate. The final supernate was derived from separated sludge containing two to three percent suspended solids. The sludge, made up of solids from primary settling, waste activated sludge from secondary treatment, and concentrate from digestate dewatering, was being further dewatered to produce the phosphorus-bearing final supernate being fed to a fluidized bed for crystallization of struvite to remove phosphorus. The dewatering was done with a rotary drum thickener followed by flat filter. The dewatering was aided by a polyacrylamide polymer (SNF, Polydyne Company) added to the wastewater in a mixture containing approximately 99% water and 1% polyacrylamide polymer.

Before adding oxalic acid, the supernate being fed to the struvite process appeared to contain residual polymer, as it was detectably more slippery, foamier, and more viscous than would otherwise be expected. The struvite particles in the reactor became agglomerated to a degree that prevented their desired fluidized-bed behavior, light-weight gelatinous material formed as floating masses, as bed inclusions, and as coatings on the walls of the reactor and in the exit conduit.

After adding oxalic acid, the struvite particles de-agglomerated and re-fluidized and the gelatinous material disappeared.

Oxalic acid contains two carboxyl groups spaced at a distance roughly similar to the space between units on the polymer, and also can function well this way because it is almost completely de-protonated at typical wastewater pH values, thus providing two anionic sites that can attach to two adjacent polymeric cationic sites. Oxalic acid may also be beneficial because, through precipitation or complexation, it can block the effects of ions, such as iron and calcium, that can interfere with struvite formation.

The method of the invention can be advantageously incorporated into wastewater treatment processes including processes that effect phosphorus removal from wastewater. Representative wastewater treatment processes suitable for incorporation of the method of the invention include those described in PCT/US2011/036514 (WO 2011/143610), PCT/US2011/049769 (WO 2012/030847), and PCT/US2011/049784 (WO 2012/030857), each expressly incorporated herein by reference in its entirety.

In general, the acid or salt thereof can be added to or introduced into any process stream that includes polyacrylamide polymer (e.g., a polyacrylamide polymer-containing stream). The acid or salt thereof can be introduced directly into a polyacrylamide polymer-containing stream or upstream from the polyacrylamide polymer-containing stream. For wastewater treatment systems that include a struvite system (i.e., phosphorus removal from wastewater), the acid or salt thereof is preferably introduced prior to (i.e., upstream from) the struvite system. In certain embodiments, the acid or salt thereof is introduced prior to solids separation in the struvite system. It will be appreciated that the points of addition of the acid and/or salt in the system include process streams that include the acid and/or salt.

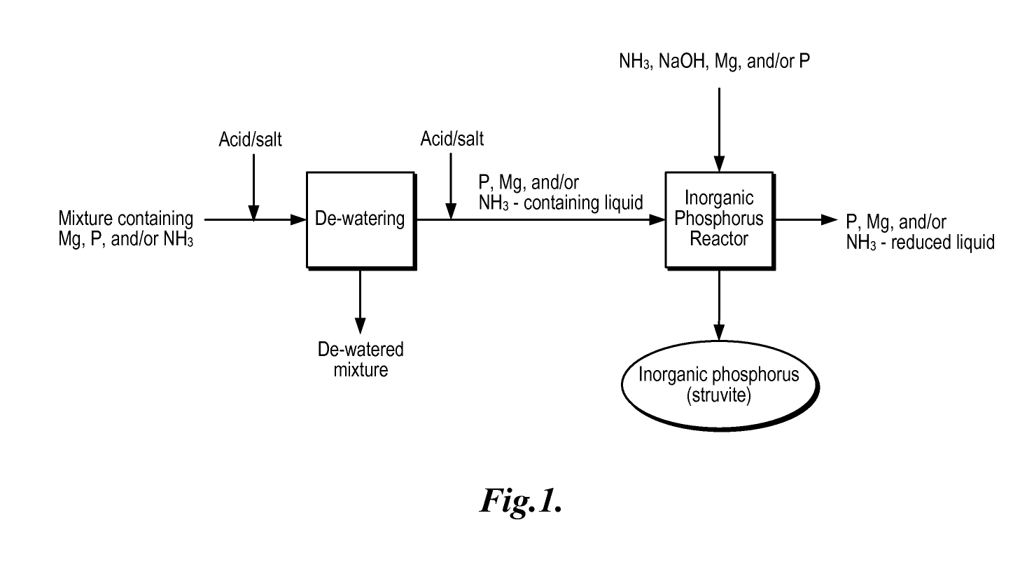

A representative wastewater treatment system that includes a struvite system for producing inorganic phosphorus (struvite) is illustrated in FIG. 1. Referring to FIG. 1, a mixture containing magnesium, phosphorus, and/or ammonia is dewatered (e.g., solids separation or thickening) to provide a dewatered mixture and a liquid containing phosphorus, magnesium, and/or ammonia. As illustrated in FIG. 1, in one embodiment, the acid and/or salt thereof is added to the mixture prior to dewatering. The liquid containing phosphorus, magnesium, and/or ammonia is then directed to an inorganic phosphorus reactor. As illustrated in FIG. 1, in a second embodiment, the acid and/or salt thereof is added to the liquid containing phosphorus, magnesium, and/or ammonia prior to introduction to the inorganic phosphorus reactor. At the reactor, magnesium and/or phosphorus are added, as needed, and pH is adjusted (e.g., addition of sodium hydroxide, ammonia, or other suitable pH booster), as necessary to provide inorganic phosphorus (e.g., struvite) and a liquid reduced in magnesium, phosphorus, and/or ammonia.

With reference to the process noted above and illustrated in FIG. 1, the acid and/or salt thereof can be introduced into the system prior to dewatering, after dewatering and prior to struvite formation, or prior to and after dewatering.

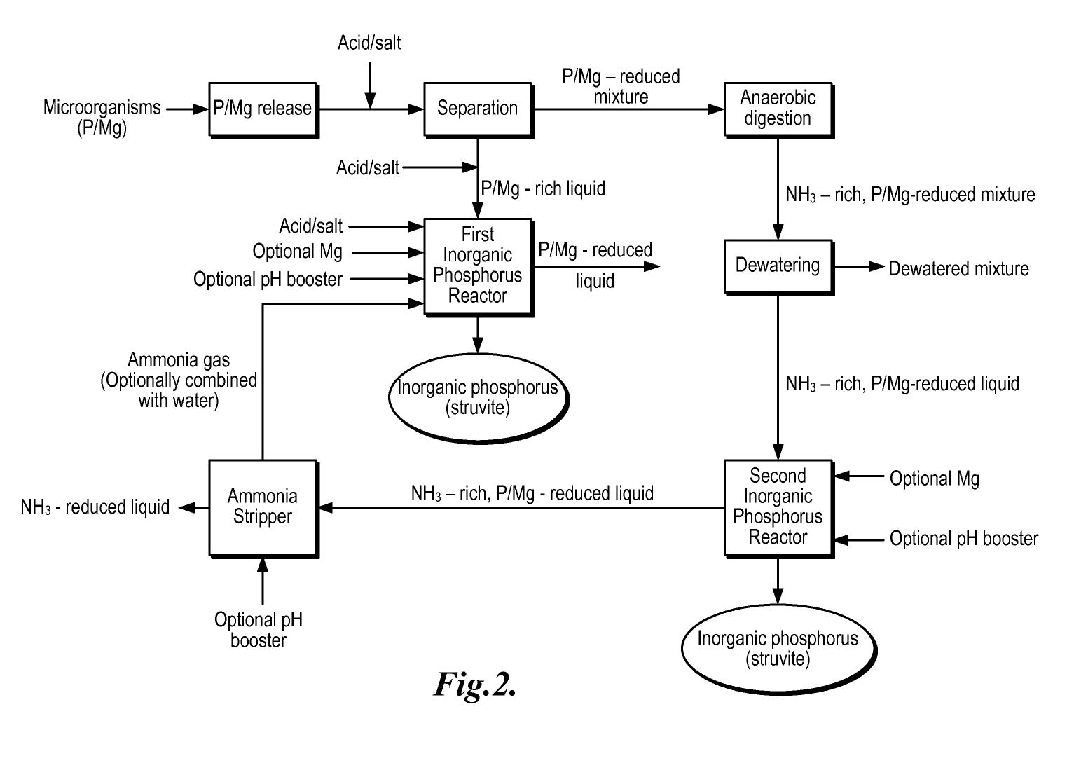

A second representative wastewater treatment system that includes a struvite system for producing inorganic phosphorus is illustrated in FIG. 2. Referring to FIG. 2, a mixture of microorganisms containing phosphorus and magnesium are induced to release phosphorus and magnesium into liquid to provide a treated mixture that includes phosphorus and magnesium. The treated mixture is then subjected to solids separation (e.g., thickening, dewatering) to provide a phosphorus- and magnesium-rich liquid and a phosphorus- and magnesium-reduced mixture. The phosphorus- and magnesium-rich liquid is conducted to a first inorganic phosphorus reactor. The phosphorus- and magnesium-reduced mixture is subjected to anaerobic digestion, where ammonia is released, to provide a first ammonia-rich, phosphorus- and magnesium-reduced mixture containing suspended solids in liquid. At this point substantially no combination of phosphorus and magnesium occurs because of the relatively low concentration of each and because the pH is low. The first ammonia-rich, phosphorus- and magnesium-reduced mixture containing suspended solids in liquid is subjected to solids separation to provide a first ammonia-rich, phosphorus- and magnesium-reduced liquid and a high biosolids portion. Solids separation of the liquid from the biosolids can be achieved by a variety of conventional means including gravity belts, filters, and centrifuges. The biosolids are removed from the system and the first ammonia-rich, phosphorus- and magnesium-reduced liquid is conducted to a second inorganic phosphorus reactor for inorganic phosphorus formation. There, magnesium is added, if needed, and pH is adjusted (e.g., addition of sodium hydroxide or other suitable pH booster), if necessary to provide inorganic phosphorus (e.g., struvite) and a second ammonia-rich, phosphorus- and magnesium-reduced liquid. The inorganic phosphorus is collected from the reactor and the high pH, second ammonia-rich, phosphorus- and magnesium-reduced liquid is ultimately conducted to the first inorganic phosphorus reactor where it is combined with the phosphorus- and magnesium-rich liquid produced from the thickening of the treated mixture containing phosphorus and magnesium from the microorganism release step. As shown in FIG. 2, the second ammonia-rich, phosphorus- and magnesium-reduced liquid can be conducted to an ammonium stripper, where the pH is adjusted as necessary (e.g., addition of sodium hydroxide or other suitable pH booster) and then on to the first inorganic phosphorus reactor. The stripper provides a low ammonia, high pH liquid, which is removed from the system, and ammonia gas, which is introduced into the first inorganic phosphorus reactor. As an alternative to introducing ammonia gas to the first inorganic phosphorus reactor, ammonia gas from the stripper can be combined with water and the resulting water containing ammonia can be added to the first reactor. Inorganic phosphorus (e.g., struvite) is formed in and ultimately collected from the first reactor. Additional ammonia or other suitable pH boosters can be added to the first reactor, as necessary. The phosphorus- and magnesium-reduced liquid produced by the first reactor can be conducted from the reactor.

With reference to the process illustrated in FIG. 2, the acid and/or salt thereof can be introduced into the system at prior to solids separation, prior to introduction of the phosphorus- and magnesium-rich liquid to the first inorganic phosphorus reactor, prior to ammonia addition to the first inorganic phosphorus reactor addition, and combinations thereof.

It will be appreciated that the wastewater treatment processes described above and illustrated in FIGS. 1 and 2 are representative wastewater treatment processes and that the method of the invention can be incorporated into any water treatment process that includes a polyacrylamide polymer-containing stream.

While the preferred embodiment of the invention has been illustrated and described, it will be appreciated that various changes can be made therein without departing from the spirit and scope of the invention.

The embodiments of the invention in which an exclusive property or privilege is claimed are defined as follows:

1. A method for inhibiting flocculation in a polyacrylamide polymer-containing wastewater treatment stream, comprising adding to a polyacrylamide polymer-containing stream an amount of an acid or salt thereof effective to inhibit flocculation formation.

2. The method of claim 1, wherein the polyacrylamide polymer is a quaternized polyacrylamide polymer.

3. The method of claim 1, wherein the acid or salt thereof is at least partially ionized at wastewater pH.

4. The method of claim 1, wherein the acid is a carboxylic acid.

5. The method of claim 4, wherein the carboxylic acid has a pKa of about 2.0.

6. The method of claim 4, wherein the carboxylic acid has a pKa of about 3.0.

7. The method of claim 4, wherein the carboxylic acid has a pKa of about 4.0.

8. The method of claim 4, wherein the carboxylic acid has a pKa of less than about 5.0.

9. The method of claim 4, wherein the carboxylic acid has two or more carboxylic acid groups.

10. The method of claim 1, wherein the acid is a dicarboxylic acid.

11. The method of claim 1, wherein the acid is oxalic acid.

12. A method for breaking apart flocculations in a polyacrylamide polymer-containing wastewater treatment stream, comprising adding to a polyacrylamide polymer-containing stream containing flocculations an amount of an acid or salt thereof effective to break apart the flocculations.

13. The method of claim 12, wherein the polyacrylamide polymer is a quaternized polyacrylamide polymer.

14. The method of claim 12, wherein the acid is at least partially ionized at wastewater pH.

15. The method of claim 12, wherein the acid is a carboxylic acid.

16. The method of claim 15, wherein the carboxylic acid has a pKa of about 2.0.

17. The method of claim 15, wherein the carboxylic acid has a pKa of about 3.0.

18. The method of claim 15, wherein the carboxylic acid has a pKa of about 4.0.

19. The method of claim 15, wherein the carboxylic acid has a pKa of less than about 5.0.

20. The method of claim 15, wherein the carboxylic acid has two or more carboxylic acid groups.

21. The method of claim 12, wherein the acid is a dicarboxylic acid.

22. The method of claim 12, wherein the acid is oxalic acid.
